(19) United States
(12) Patent Application Publication
(10) Pub. No.: US 2008/0298586 A1
(43) Pub. Date: Dec. 4, 2008

(54) Decryption System and Method for Video Data

(75) Inventors: Janghwan Lee, Westfield, IN (US); Bret David Hawkins, Brownsburg, IN (US); Charles William Worrell, Carmel, IN (US)

Correspondence Address: FLETCHER YODER P.C., 7915 FM 1960 RD. WEST, SUITE 330, HOUSTON, TX, 77070, US

(73) Assignee: TTE TECHNOLOGY, INC., Indianapolis, IN (US)

(21) Appl. No.: 12/097,877

(22) PCT Filed: Dec. 20, 2005
(86) PCT No.: PCT/US05/46281

§ 371 Date: Jun. 17, 2008

(51) Int. Cl. H04N 7/167

(52) U.S. Cl. 380/210

(57) ABSTRACT

The disclosed embodiments relate to a system that processes video data. An exemplary embodiment of the system includes a module that initiates a channel search procedure on a transport stream, a module that determines an encryption level of a first channel in the transport stream based on a control bit within the transport stream, and a module that adds the first channel and its associated encryption level to a channel map.

### FIELD OF THE INVENTION

This invention relates to the field of digital signal processing, including providing improved performance in systems that employ both decoding and decryption of video data.

### BACKGROUND OF THE INVENTION

This section is intended to introduce the reader to various aspects of art which may be related to various aspects of the present invention which are described and/or claimed below. This discussion is believed to be helpful in providing the reader with background information to facilitate a better understanding of the various aspects of the present invention. Accordingly, it should be understood that these statements are to be read in this light, and not as admissions of prior art.

In video processing and storage applications, digital video data is typically encoded to conform to the requirements of a known standard. One such widely adopted standard is the MPEG2 (Moving Pictures Expert Group) image encoding standard, hereinafter referred to as the “MPEG standard”. The MPEG standard is comprised of a system encoding section (ISO/IEC 13818-1, 10 Jun. 1994) and a video encoding section (ISO/IEC 13818-2, 20 Jan. 1995), hereinafter referred to as the “MPEG systems standard” and “MPEG video standard” respectively. Video data encoded to the MPEG standard is in the form of a packetized datastream, which typically includes the data content of many program channels (analogous to channels 1-125 in cable TV, for example). The data content of premium program channels such as HBO™, Cinemax™ and Showtime™, for example, is usually protected from unauthorized access by methods such as encryption and scrambling. These methods may be used alone, repetitively, or in combination to provide a plurality of levels of protection.

In a decoder, access to the premium channels is typically governed by a conditional access system which manages user billing and controls program descrambling and decryption based on user entitlement. The conditional access system may determine whether access is authorized in a variety of ways. For example, authorization may be determined within the decoder from user entitlement information pre-programmed on a so-called “smart card”. Alternatively, authorization may be determined at a remote location and implemented within the decoder using user entitlement information that is transmitted from the remote location, as in a cable television pay-per-view service. The entitlement information typically includes codes used to generate descrambling and decryption keys that are used for program descrambling and decryption. However, the entitlement information may instead include the keys themselves.

The processing of encrypted and non-encrypted program data and the management of associated encryption and scrambling codes for storage, billing and other applications presents a number of problems. One such problem relates to the fact that decryption of video data is typically handled in a different hardware block than video/audio decoding. This results in a potential timing mismatch between the two respective blocks, making it difficult to determine whether to decrypt a new stream of data before starting to decode that stream. A system and method of improving this potential timing mismatch and facilitating a smooth transition to decoding a video stream is desirable. Hereinafter the term “encryption” encompasses scrambling functions to the extent that the functions are used to prevent unauthorized use.

### SUMMARY OF THE INVENTION

The disclosed embodiments relate to a system that processes video data. An exemplary embodiment of the system includes a module that initiates a channel search procedure on a transport stream, a module that determines an encryption level of a first channel in the transport stream based on a control bit within the transport stream, and a module that adds the first channel and its associated encryption level to a channel map.

### BRIEF DESCRIPTION OF THE DRAWINGS

In the drawings:

FIG. 1 is a block diagram of a video system in accordance with an exemplary embodiment of the present invention;

FIG. 2 is a flow diagram of a channel search operation in accordance with an exemplary embodiment of the present invention; and

FIG. 3 is a flow diagram of a video display operation in accordance with an exemplary embodiment of the present invention.

### DETAILED DESCRIPTION OF THE PREFERRED EMBODIMENTS

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions may be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

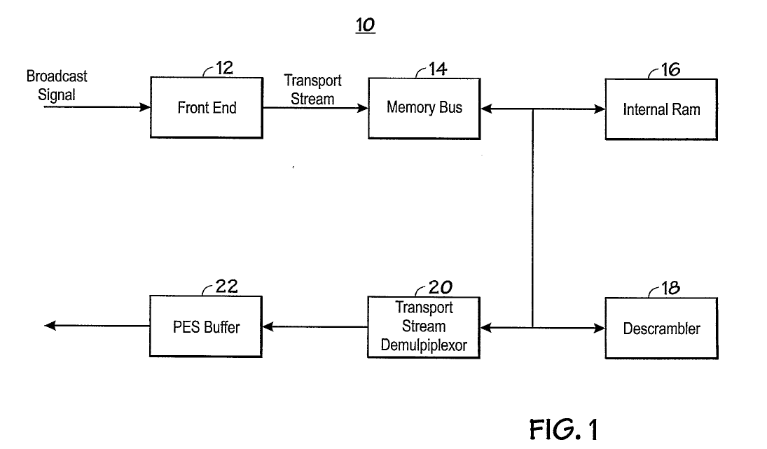

FIG. 1 is a block diagram of a video system in accordance with an exemplary embodiment of the present invention. The system is generally referred to by the reference number 10. The system 10 comprises a front end unit 12, which may include a tuner, an input processor and the like. The specific functions and details of construction of the front unit 12 are not an essential aspect of the present invention. Generally, the front unit 12 is adapted to receive an input signal such as a broadcast signal and to prepare that signal for further processing by the remaining components of the system 10.

Transport stream data is delivered by the front end unit 12 to a memory bus 14. The memory bus delivers a transport stream to an internal RAM 16, a descrambler 18, and a transport stream demultiplexor (“TSD”) 20. In the exemplary embodiment illustrated in FIG. 1, the descrambler 18 and the TSD 20 share the internal RAM 16. The sharing of the internal RAM 16 enables the descrambler 18 to decrypt video data before that data is presented to the TSD 20. This means that video data stored in the internal RAM 16 would be decrypted before it is accessed by the TSD 20. In this manner, encrypted packet encoding stream (“PES”) data would not be presented to the TSD 20 if the descrambler 18 is able to decode that data.

The descrambler 18 may be able to decrypt video data using scrambling bit information included in a transport stream packet and PES layer data previously provided by the front end unit 12. Those bits include decryption information for encrypted video data. As set forth below, information determined during a typical channel search may be employed to optimize video and audio decoding in accordance with an exemplary embodiment of the present invention. The system 10 may be adapted to perform a channel search upon initialization.

In the exemplary embodiment illustrated in FIG. 1, video data is decrypted in the descrambler 18 using transport scrambling control bits from a transport stream packet and PES scrambling control bits from PES packet data. Examples of transport scrambling information and PES scrambling control information are set forth in the MPEG2 system specification, which is hereby incorporated by reference. Exemplary transport scrambling information is referred to in table 2-2 of MPEG2 system specification as transport_scrambling_control bits. Exemplary PES scrambling control information is referred to in table 2-17 (PES packet) of the MPEG2 system specification as PES_scrambling_control bits.

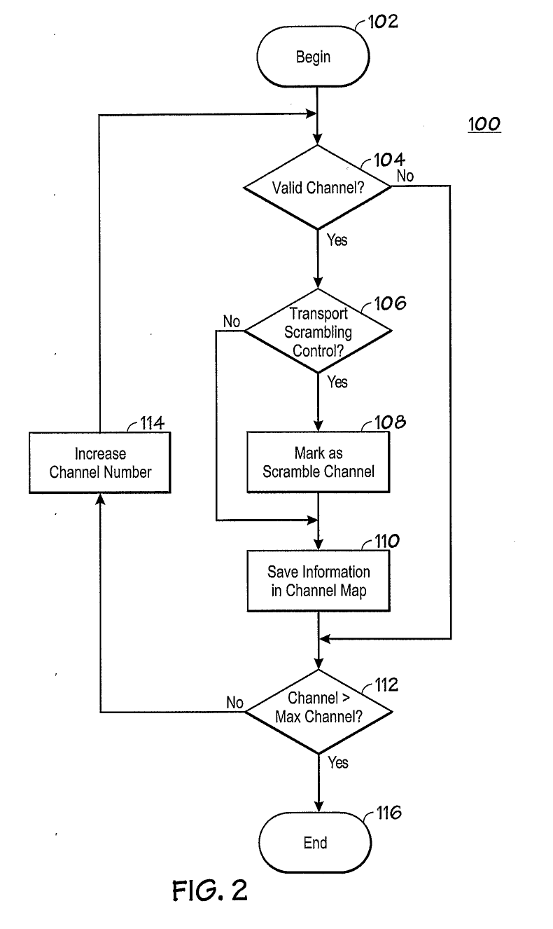

FIG. 2 is a flow diagram of a channel search operation in accordance with an exemplary embodiment of the present invention. The process is generally referred to by the reference numeral 100. Those of ordinary skill in the art will appreciate that the functionality illustrated in FIG. 2 may be implemented in a system such as the system 10 (FIG. 1) in the form of hardware modules, software modules or some combination thereof, depending on considerations relevant to specific design goals. If software modules are employed, the software modules may comprise computer-readable instructions stored on a tangible medium, such as in a RAM or ROM device.

In accordance with the exemplary process 100, a channel searching procedure is performed. During the channel search procedure, encrypted channels are marked based on information contained in transport scrambling control bits received with the video signal. This information is previously obtained from program specific information (“PSI”) during the making of a channel map, which may be performed as a part of initializing the system 10 (FIG. 1). Accordingly, that information is available for reuse during the channel search operation illustrated in FIG. 2.

At block 102, the exemplary channel search process 100 begins. At a decision block 104, a decision is made about whether the channel being examined is valid. If the channel is determined to be invalid, process flow continues to decision block 112, as illustrated in FIG. 2. At decision block 112, a determination is made as to whether the current channel number is greater than a predetermined maximum channel number. If the channel number is less than the predetermined maximum channel number, process flow continues at block 114, where the channel number is incremented. Thereafter, process flow continues with the incremented channel number at the decision block 104. If the result of the decision block 112 is that the channel is greater than the predetermined maximum channel number, the process ends, as illustrated at block 116.

If, at the decision block 104, a channel is determined to be valid, process flow continues at decision block 106. At a decision block 106, a determination is made regarding an encryption level of the channel being evaluated. Specifically, the channel is evaluated for the presence of control bits in the form of transport scrambling control information. If the channel employs transport control, the channel is marked as a scrambled channel at block 108. If, at decision block 106, the channel is determined to not employ transport scrambling control, block 108 is skipped and process flow continues at block 110. At block 110, information about the channel, including whether it is encrypted or not, is saved in a channel map in the system 10 (FIG. 1) for later access. Thereafter, process flow continues at decision block 112, where the process 100 is repeated for successive channels up to and including the predetermined maximum channel number. After the channel corresponding to the predetermined maximum channel number is processed, process flow ends, as illustrated at block 116.

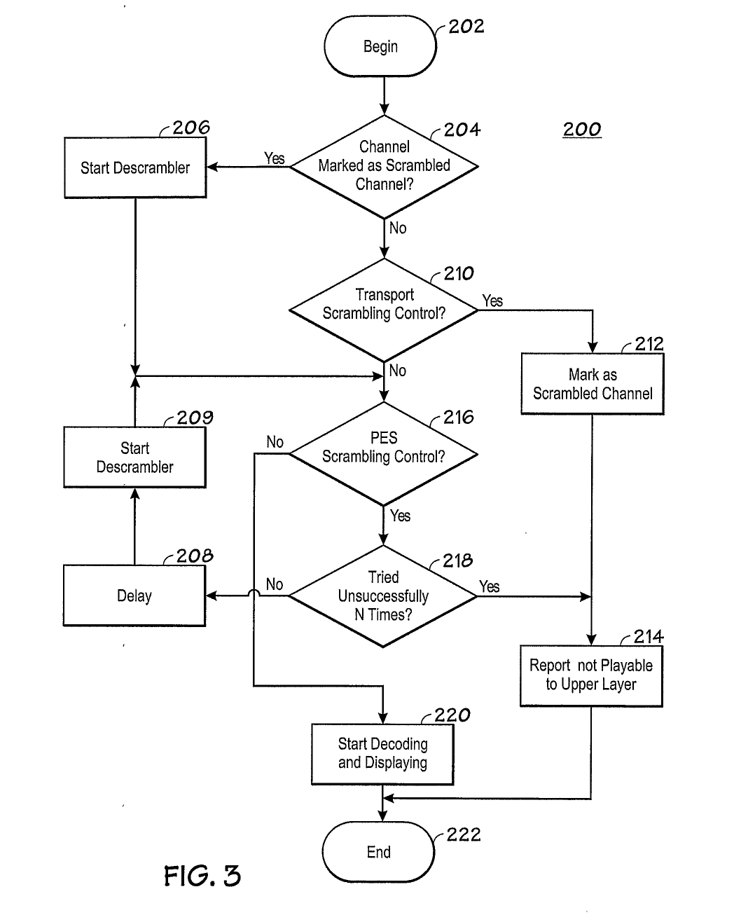

FIG. 3 is a flow diagram of a video play operation in accordance with an exemplary embodiment of the present invention. The process is generally illustrated by the reference numeral 200. Those of ordinary skill in the art will appreciate that the functionality illustrated in FIG. 3 may be implemented in a system such as the system 10 (FIG. 1) in the form of hardware modules, software modules or some combination thereof, depending on considerations relevant to specific design goals. If software modules are employed, the software modules may comprise computer-readable instructions stored on a tangible medium, such as in a RAM or ROM device.

The exemplary process illustrated in FIG. 3 may be followed, for example, when a user of the system 10 (FIG. 1) changes a channel that is being displayed by the system. Playback of the channel may begin based on decryption performed by the descrambler 18, for channels indicated to be scrambled as a result of the process illustrated in FIG. 2. If changes have occurred in encryption information in the transport scrambling control, or if decrypted PES information is not available, this condition may be reported to a higher software layer with a request to update encryption information in the channel map.

When a play command is receive, transport scrambling control bits associated with the requested channel may be checked to see if they have changed since last being updated. If the transport control bits have changed, this condition may be reported to a higher software layer, as described previously. As a result of this request, new encryption data may be obtained for the specific channel before it is played.

In the exemplary embodiment illustrated in FIG. 3, PES scrambling control information may be employed to determine if the descrambler 18 (FIG. 1) is descrambling video correctly with the decryption information that is provided. It may be desirable to provide a number of trials before deciding that the video information is not susceptible to decryption using the currently available decryption information. For example, three attempts may be made before deciding that data is not susceptible to decryption. As explained below, a delay may be inserted between each of these trials to facilitate improved performance.

At block 202, the process begins. At a decision block 204, a determination is made as to whether the channel for which playback has been requested is marked as scrambled. The channel may have been determined to be scrambled and marked as such by execution of the process illustrated in FIG. 2. If the channel is scrambled, descrambler 18 (FIG. 1) may be started, as illustrated at block 206. The descrambler 18 will attempt to decrypt the video information using the encryption data previously obtained, as described above. After the descrambler is started at block 206, process flow continues at a decision block 216, as described below.

If, as a result of the determination at the decision block 204, the channel is not identified as scrambled, process flow continues to a decision block 210. At block 210, a decision is made as to whether the channel employs transport scrambling control. If the channel employs transport scrambling control, it is marked as scrambled, as shown at block 212. Process flow then continues to block 214, where the channel is reported to an upper level software layer as not being playable. The upper layer software level may request updated encryption information before the channel can be displayed. Thereafter, the process ends, as illustrated at block 222.

If, at decision block 210, the channel is determined to not employ transport scrambling control, process flow continues at decision block 216, where a determination is made as to whether the channel employs PES scrambling control. If the channel does not employ PES scrambling control, process flow continues at block 220, where the channel is decoded and displayed. The process ends at block 222.

If the channel is determined to employ PES scrambling control at the decision block 216, process flow continues to a decision block 218. In an exemplary embodiment of the present invention, the decision block 216 may be adapted to determine whether decryption information already stored in the internal RAM 16 (FIG. 1) is correctly decrypting video data. If decryption data already stored in the internal RAM 16 (FIG. 1) works correctly, requested playback of the channel may begin sooner than if new decryption information has to be obtained by accessing a higher software layer for an update to the decryption information stored in the channel map.

At the decision block 218, a determination is made as to how many unsuccessful attempts to decode video correctly with existing PES information have taken place so far. In block 218, the number of unsuccessful passes is indicated as “N.” The value of “N” may be determined by a system design considerations to optimize delay in presentation of a displayed image after playback is requested (for example, when a user changes the channel on a television). If the maximum “N” number of unsuccessful passes has not been reached, process flow continues at block 208 where a delay is incurred. Based on inherent delays in the operation of the descrambler 18 (FIG. 1), the delay may be programmed to be in the range of about 10 milliseconds to about 1 second. Following the delay, the descrambler is started, as illustrated at block 209, using existing decryption information. Process flow then returns to block 216, where a decision is again made as to whether PES scrambling control information is being employed. As set forth above, this determination may include a determination of whether video information is being decoded correctly with the existing PES decryption information.

If, at the decision block 218, the maximum number of unsuccessful passes through the process 200 has been reached, the channel is reported as unplayable to an upper layer program, as illustrated at block 214. Updated decryption information may be obtained via the upper layer program prior to retrying playback of the video information. Thereafter, process flow ends at block 222.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A system, comprising:
a module adapted to initiate a channel search procedure on a transport stream;
a module adapted to determine an encryption level of a first channel in the transport stream based on a control bit within the transport stream; and
a module adapted to add the first channel and its associated encryption level to a channel map.

2. The system recited in claim 1, wherein the control bit comprises at least a portion of transport scrambling control information associated with the first channel.

3. The system recited in claim 1, comprising a module adapted to start a descrambler to process the first channel if the associated encryption level indicates that the first channel is encrypted.

4. The system recited in claim 1, comprising a module adapted to mark the first channel as an encrypted channel if the associated encryption level indicates that the first channel is encrypted.

5. The system recited in claim 1, comprising a module adapted to determine if the first channel is a valid channel.

6. The system recited in claim 1, comprising a module adapted to determine if the first channel is associated with packet encoding stream (“PES”) data.

7. The system recited in claim 6, wherein the module adapted to determine if the first channel is associated with PES data is further adapted to determine if the first channel is being correctly decoded.

8. The system recited in claim 6, comprising:
a module adapted to delay for a predetermined time if the first channel is associated with PES data; and
a module adapted to determine if the first channel is being correctly decoded following the delay.

9. The system recited in claim 6, comprising a module adapted to decode the first channel if the first channel is not associated with PES data.

10. A method, comprising:
initiating a channel search procedure on a transport stream;
determining an encryption level of a first channel in the transport stream based on a control bit within the transport stream; and
adding the first channel and its associated encryption level to a channel map.

11. The method recited in claim 10, comprising starting a descrambler to process the first channel if the associated encryption level indicates that the first channel is encrypted.

12. The method recited in claim 10, comprising marking the first channel as an encrypted channel if the associated encryption level indicates that the first channel is encrypted.

13. The method recited in claim 10, comprising determining if the first channel is associated with packet encoding stream (“PES”) data.

14. The method recited in claim 13, comprising:
delaying for a predetermined time if the first channel is associated with PES data; and
determining if the first channel is being correctly decoded following the delay.

15. The method recited in claim 13, comprising decoding the first channel if the first channel is not associated with PES data.

16. A tangible machine-readable medium, comprising:
code adapted to initiate a channel search procedure on a transport stream;
code adapted to determine an encryption level of a first channel in the transport stream based on a control bit within the transport stream; and
code adapted to add the first channel and its associated encryption level to a channel map.

17. The tangible machine-readable medium recited in claim 16, comprising code adapted to start a descrambler to process the first channel if the associated encryption level indicates that the first channel is encrypted.

18. The tangible machine-readable medium recited in claim 16, comprising code adapted to descramble the first channel if the associated encryption level indicates that the first channel is encrypted.

19. The tangible machine-readable medium recited in claim 16, comprising code adapted to mark the first channel as an encrypted channel if the associated encryption level indicates that the first channel is encrypted.

20. The tangible machine-readable medium recited in claim 16, comprising code adapted to determine if the first channel is associated with packet encoding stream data.
